(19) United States
(12) Patent Application Publication
(10) Pub. No.: US 2025/0118727 A1
(43) Pub. Date: Apr. 10, 2025

(54) CONDUCTIVE MATERIALS MIXTURE AND LAYER FOR MANGANESE RICH CATHODE ELECTRODE

(71) Applicant: FORD GLOBAL TECHNOLOGIES, LLC, Dearborn, MI (US)

(72) Inventors: Jonghwan PARK, Ann Arbor, MI (US); Insik JEON, Novi, MI (US)

(21) Appl. No.: 18/481,575

(22) Filed: Oct. 5, 2023

(51) Int. Cl. H01M 4/131; H01M 4/02; H01M 4/04; H01M 4/1391; H01M 4/36; H01M 4/505; H01M 4/62; H01M 4/66; H01M 10/0525

(52) U.S. Cl. CPC H01M 4/131; H01M 4/0404; H01M 4/043; H01M 4/1391; H01M 4/366; H01M 4/505; H01M 4/623; H01M 4/625; H01M 4/661; H01M 10/0525; H01M 2004/021; H01M 2004/028

(57) ABSTRACT

A lithium-ion battery with an enhanced electrode structure and methods for forming such an electrode structure. The electrode assembly comprises a pre-coat layer compressed with a metal current collector on which a lithium-manganese rich active layer is then deposited and compressed to form the assembly. The disclosed electrode structure reduces internal resistance.

### TECHNICAL FIELD

This disclosure relates to electrode materials for lithium-ion batteries.

### BACKGROUND

Lithium-ion batteries are widely used in various applications. One of the contributors to lithium-ion battery performance is the electrode structure, which plays a role in the energy density, power density, and cycle life of the battery. Within this context, different cathode materials have been studied to optimize these properties. Manganese-rich cathodes have higher internal resistance compared to high nickel, nickel cobalt manganese cell formations. Pre-coated conductive layers on a current collector can reduce interfacial resistance.

### SUMMARY

In one aspect, the electrode assembly comprises a metal current collector, a coating of interspersed carbon, carbon nanotubes, and binder compressed with and on the metal current collector, and a lithium-manganese rich (LMR) positive electrode layer compressed with the metal current collector and on the coating such that the coating is between the metal current collector and the lithium-manganese rich positive electrode layer.

In one embodiment, the coating further comprises ultra-high BET carbon and acetylene black. In another embodiment, the carbon nanotubes comprise a mixture of multi-wall carbon nanotubes and single-wall carbon nanotubes. In yet another embodiment, the metal current collector is a metal foil, such as aluminum. In still another embodiment, the binder is acrylic acid or modified polyvinylidene fluoride (PVDF). In some embodiments the thickness of the pre-coated layer can be controlled to be between 0.5˜20 μm, and the mean particle size can be controlled to be between 0.1˜10 μm.

In other embodiments, the pre-coated layer is pressed solely prior to being pressed with the lithium-manganese rich positive electrode layer. In additional embodiments, the electrode assembly comprises carbon nanotubes blended with polymer beads and BaTiO₃, where the BaTiO₃ particles constitute 10-80% of the blend.

In another aspect, the present disclosure relates to a method for manufacturing an electrode assembly. The method comprises creating a pre-coat layer by applying a coating of interspersed carbon, carbon nanotubes, ultra-high BET carbon, and binder on a metal current collector; pressing the pre-coat layer onto the metal current collector, applying a LMR slurry also on the pre-coat layer, and pressing the LMR slurry onto the pre-coat layer such that the pre-coat is between the metal current collector and the lithium-manganese rich electrode layer.

In some embodiments, the LMR slurry further comprises acetylene black and ultra-high BET carbon. In other embodiments, the carbon nanotubes comprise a mixture of multi-wall carbon nanotubes and single-wall carbon nanotubes. In further embodiments, the binder used is acrylic acid which can be modified PVDF. In yet further embodiments, the method further comprises blending polymer beads and BaTiO₃ as a binder, wherein the blending ratio of BaTiO₃ particles with polymer bead is between 10-80%.

In yet another aspect, the present disclosure relates to a battery comprising a current collector, an electrolyte, a separator, and a pre-coat layer directly compressed onto the metal current collector foil. The pre-coat layer includes a blend of interspersed carbon, both single and multi-walled carbon nanotubes, ultra-high BET carbon, and a lithium-manganese rich carbon black electrode layer positioned directly atop said pre-coat layer and in direct contact therewith.

### BRIEF DESCRIPTION OF THE DRAWINGS

FIG. 1 is a schematic cross-sectional view of an electrode assembly according to one embodiment.

FIG. 2 is a schematic cross-sectional view of a pre-coat layer.

FIG. 3 is a schematic cross-sectional view of a LMR layer according to one embodiment.

FIG. 4. is a flowchart of an electrode assembly process.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Lithium manganese-rich electrodes, commonly referred to as LMR, can have increased internal resistance when in a low state-of-charge (SOC) region, which affects cell performance and efficiency. This disclosure introduces a layering method that incorporates conductive materials. Carbon and carbon nanotubes (CNTs), known for their conductive properties, are utilized to form a pre-coat on a current collector. This pre-coat combines both carbon black and ultra-high surface carbon with single and multi-wall carbon nanotubes. On top of the pre-coated current collector an LMR slurry is deposited. The interfacial resistance of electrode assembly can be increased with the incorporation of ultra-high surface area carbon as characterized by the Brunauer, Emmett, and Teller method (BET carbon) and acetylene black, a type of carbon black. The interaction between the pre-coat and the cathode creates an interface with reduced surface charge transfer resistance.

The layered approach can result in a reduction in internal cell resistance, potentially improving power capability. The combining of conductive materials, such as acetylene black and ultra-high BET carbon with CNTs, establishes a two-tiered conductive layer. This layering method lowers the resistance in cathode electrodes. In one embodiment, the LMR cathode may integrate specific proportions of ultra-high BET carbon, acetylene black, and other conductive materials to achieve increased resistance reduction. This combination can vary depending on results and production methods. Another embodiment may incorporate variations in the layering method, wherein the sequence, composition, or density of the layers may be altered to achieve specific performance criteria.

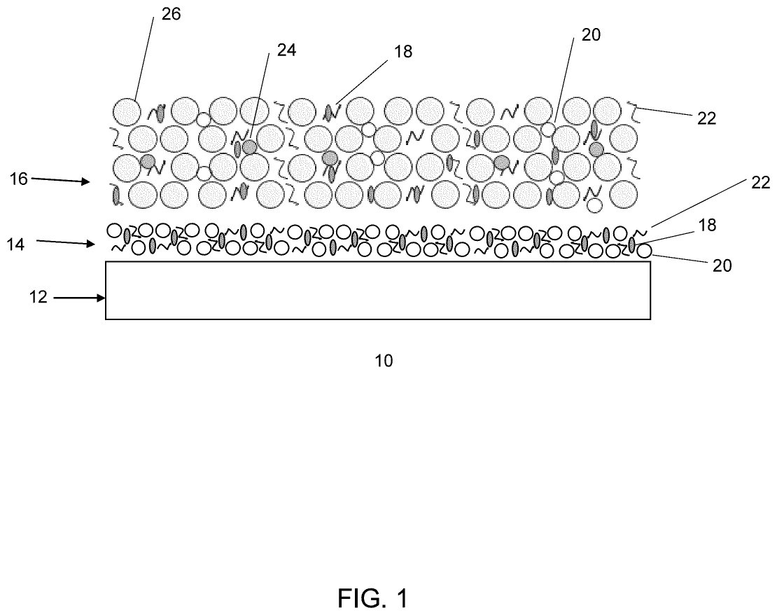

Referring now to the drawings, FIG. 1 illustrates a schematic cross-sectional view of an electrode assembly 10 according to one embodiment of the disclosure. The electrode assembly 10 has a current collector 12, a pre-coat layer 14, and a slurry layer 16. The current collector 12 serves as a foundational layer and can be a metal current collector which can be aluminum. The pre-coat layer 14 is deposited onto the current collector 12 and can contain carbon nanotubes 18, ultra-high surface carbon black 20, and a binder 22, which can be an acrylic acid such as modified polyvinylidene fluoride (PVDF). The binder 22 can also comprise a blend of polymer beads and BaTiO₃. The blending ratio of BaTiO₃ particles in the binder 22 ranges from about 10% to about 80%. BaTiO₃, a ceramic material, combined with polymer beads produces carbon nanotubes with suitable dielectric properties The mean particle size of the pre-coat layer14 can be controlled to be within 0.1˜10 μm. The thickness of the pre-coated layer can be controlled to be between 0.5˜20 μm. The slurry layer 16 applied on the pre-coat layer 14 can also contain carbon nanotubes 18, ultra-high surface carbon black 20, binder 22, acetylene black 24, and cathode materials 26. The cathode materials 26 can be LMR particles that facilitate primary electrochemical reactions. The cathode materials 26 distinguish the slurry layer as the LMR layer.

The carbon nanotubes 18 of the pre-coat layer 14 and the slurry layer 16 can comprise a mixture of single-walled carbon nanotubes (SWCNTs) and multi-walled carbon nanotubes (MWCNTs). The proportions of the mixture can be determined by the mechanical properties for the application, MWCNTs provide mechanical strength due to their multi-layered concentric cylindrical structure, while SWCNTs have higher electrical conductivity. The differing geometries and sizes between SWCNTs and MWCNTs can lead to better dispersion in the incorporated layers. The pre-coat layer 14 also contains ultra-high surface carbon black 20, often referred to as “BET carbon,” which is a form of carbon black with a large surface area. This expansive surface area is quantitatively characterized using the Brunauer, Emmett, and Teller (BET) method, a technique for measuring the surface area of porous materials. BET carbon's surface characteristics correlate to its adsorption capacity. Carbon particularly showing the BET characterized surface characteristics will be referred to as ultra-high BET carbon.

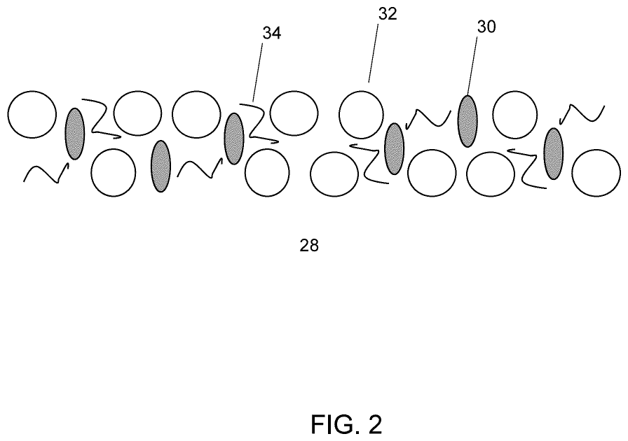

Referring now to FIG. 2, a schematic cross-sectional depiction of the pre-coat layer 28 is shown. This pre-coat layer 28 contains carbon nanotubes 30, which can be a combination of SWCNTs and MWCNTs. The mixture of SWCNTs and MWCNTs is influenced by specific mechanical properties for the application. For instance, MWCNTs, with their multi-layered concentric cylindrical design, offer mechanical strength, while SWCNTs are known for their higher electrical conductivity. Also included in the composition of the pre-coat layer 28 is ultra-high surface carbon black 32. This specific type of carbon black, commonly referred to as “BET carbon,” has vast surface area. The measurement of this surface area is done using the Brunauer, Emmett, and Teller (BET) technique, a method for quantifying the surface area of porous materials. The high surface area of BET carbon correlates to higher absorptive capacities relative to low surface area carbon. To provide structural cohesion, the average particle size of the pre-coat layer 28 is preferably within the range of 0.1˜10 μm, and the overall thickness of the pre-coat layer 28 is preferably between 0.5˜20 μm. Additionally, the pre-coat layer 28 also contains a binder 34 which can be an acrylic acid such as PVDF which has been modified or slightly treated to be better suited as a binder. The binder 34 can also be comprised of a mixture of polymer bead and BaTiO₃. The percentage of BaTiO₃ particles, a ceramic material with specific properties, can be between 10% to 80% of the blend. The composition of the carbon nanotubes can be modified to alter their dielectric properties.

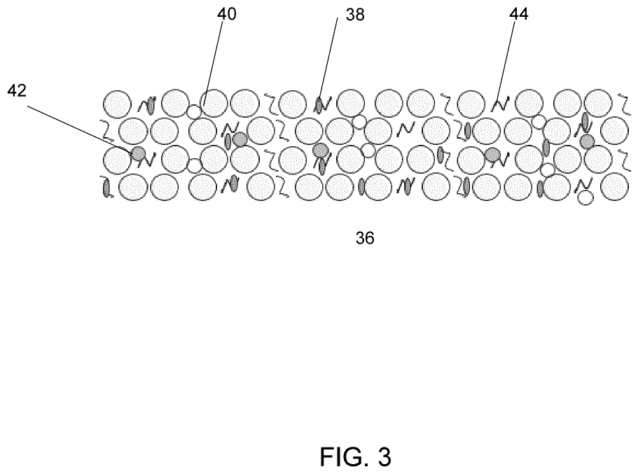

Referring to FIG. 3, the diagram presents a cross-sectional depiction of the slurry layer 36. This slurry layer 36 is applied atop the pre-coat layer to form the electrode assembly. Within the slurry layer 36, there are carbon nanotubes 38, which may be a mixture of both SWCNTs and MWCNTs. Depending on the specific mechanical attributes for the application, the proportion of SWCNTs to MWCNTs can be varied. In addition to the carbon nanotubes, the slurry layer 36 incorporates ultra-high surface carbon black 40, which is distinguished by its surface area as measured by the BET technique, and acetylene black 42 to decrease interfacial resistance. The presence of BET carbon in the slurry layer is for its adsorptive capacities. Furthermore, the slurry layer 36 may contain other cathode materials 42, such as LMR particles, for the primary electrochemical processes in the cell. The slurry layer is also an LMR layer when cured to form a solid active layer. The LMR layer 36 also contains a binder 44 which can be an acrylic acid such as modified PVDF. The binder 44 can also be comprised of a blend of polymer bead and BaTiO₃, with BaTiO₃ constituting between 10% to 80% of this blend. This specific ratio of BaTiO₃ in the blend alters the dielectric characteristics of the binder 44.

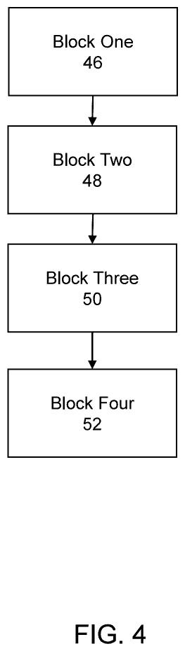

Referring now to FIG. 4, the flowchart presents a sequential process in the preparation of an electrode assembly according to one embodiment of the disclosure. The process begins with Block One 46, which represents a current collector, a foundational component for subsequent steps. A pre-coat layer is then applied directly to this current collector. Proceeding to Block Two 48, the pre-coat layer, along with the underlying current collector, undergoes a pressing process. This compression increases the adherence and uniformity of the pre-coat layer upon the current collector, preparing it for the next stage. In Block Three 50, a slurry layer is applied directly atop the previously pressed pre-coat layer. This slurry layer encapsulates various components, including carbon nanotubes (both SWCNTs and MWCNTs), ultra-high BET carbon, acetylene black/carbon black, and possibly other cathode materials such as lithium LMR particles. Block Four 52 represents the final formation step, where the slurry layer, pre-coat layer, and the current collector are collectively pressed. This pressing process helps to form a cohesive electrode assembly.

The algorithms, methods, or processes disclosed or suggested herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electrode assembly comprising:
a metal current collector;
a coating of interspersed carbon, carbon nanotubes, and binder compressed with and on the metal current collector; and
a lithium-manganese rich (LMR) positive electrode layer compressed with the metal current collector and on the coating such that the coating is between the metal current collector and the lithium-manganese rich positive electrode layer.

2. The electrode assembly of claim 1, wherein the coating further comprises ultra-high BET carbon.

3. The electrode assembly of claim 1, wherein the coating further comprises acetylene black.

4. The electrode assembly of claim 1, wherein the carbon nanotubes comprise a mixture of multi-wall carbon nanotubes and single-wall carbon nanotubes.

5. The electrode assembly of claim 1, wherein the metal current collector is a metal foil.

6. The electrode assembly of claim 5, wherein the metal foil is aluminum.

7. The electrode assembly of claim 1, wherein the binder comprises an acrylic acid.

8. The electrode assembly of claim 7, wherein the acrylic acid is a modified polyvinylidene fluoride.

9. The electrode assembly of claim 1, wherein an average particle size of the coating is between 0.1 to 10 μm.

10. The electrode assembly of claim 1, wherein a thickness of the coating is between 0.5 to 20 μm.

11. The electrode assembly of claim 1, wherein the LMR positive electrode layer also contains acetylene black.

12. The electrode assembly of claim 1, where the binder further comprises a blend of polymer bead and BaTiO₃ in the coating.

13. The electrode assembly of claim 12, wherein a blend ratio of BaTiO₃ particles with polymer bead is in a range from 10% to 80%.

14. A method comprising:
pressing a coating of interspersed carbon, carbon nanotubes, ultra-high BET carbon, and binder on a metal current collector;
applying a lithium-manganese rich (LMR) slurry of acetylene black and carbon nanotubes atop; and
pressing the LMR slurry onto the coating such that the coating is between the metal current collector and the LMR slurry.

15. The method of claim 14, wherein the LMR rich slurry further comprises ultra-high BET carbon.

16. The method of claim 14, wherein the carbon nanotubes comprise a mixture of multi-wall carbon nanotubes and single-wall carbon nanotubes.

17. The method of claim 14, wherein the binder comprises an acrylic acid.

18. The method of claim 17, wherein the acrylic acid is a modified polyvinylidene fluoride.

19. The method of claim 14, wherein the binder further comprises blending polymer beads and BaTiO₃.

20. A battery comprising:
an electrolyte;
a separator; and
an electrode with a lithium-manganese rich layer of acetylene black and carbon nanotubes compressed directly atop and in direct contact with a pre-coat layer of interspersed carbon, carbon nanotubes, and ultra-high BET carbon on a current collector foil.
